(19) United States
(12) Patent Application Publication
(10) Pub. No.: US 2017/0262096 A1
(43) Pub. Date: Sep. 14, 2017

(54) TOUCH PANEL AND ELECTRONIC DEVICE INCLUDING THE SAME

(71) Applicant: Samsung Electronics Co., Ltd., Gyeonggi-do (KR)

(72) Inventors: Min Uk KIM, Gyeonggi-do (KR); Hoon Do Heo, Gyeonggi-do (KR)

(73) Assignee: Samsung Electronics Co., Ltd.

(21) Appl. No.: 15/454,619

(22) Filed: Mar. 9, 2017

(30) Foreign Application Priority Data
Mar. 9, 2016 (KR) 10-2016-0028421

(51) Int. Cl. G06F 3/044; G06F 3/041

(52) U.S. Cl. CPC G06F 3/044; G06F 3/0416; G06F 2203/04112

(57) ABSTRACT

A touch panel is provided and includes an electrode pattern including a plurality of driving electrodes and a plurality of sensing electrodes, and an insulating part formed between at least some of the plurality of driving electrodes and at least some of the plurality of sensing electrodes. The plurality of driving electrodes include a first driving electrode and a second driving electrode that are formed of a first material, a portion of the first driving electrode and a portion of the second driving electrode maintain a first distance and are disposed to be parallel with each other, the plurality of sensing electrodes include a first sensing electrode and a second sensing electrode that are formed of a second material, and a portion of the first sensing electrode and a portion of the second sensing electrode maintain a second distance different from the first distance and are disposed to be parallel with each other.

### PRIORITY

This application claims priority under 35 U.S.C. §119(a) to a Korean Patent Application filed on Mar. 9, 2016 in the Korean Intellectual Property Office and assigned Serial No. 10-2016-0028421, the entire disclosure of which is incorporated herein by reference.

### BACKGROUND

1. Field of the Disclosure

The present disclosure relates a touch panel and an electronic device including the same.

2. Description of the Related Art

An electronic device such as a smart phone or a tablet PC may perform various functions including wireless data communication, a media output, etc. The electronic device uses a touch panel as a way to recognize an input of a user. The touch panel is typically a capacitive touch panel or a resistive touch panel.

In the case of the capacitive touch panel, if a user touches a screen of an electronic device by using a portion (e.g., a finger) of his/her body or a touch input device (e.g., a touch pen), the capacitance of the touch panel may change with respect to a touch point. The touch panel may transmit the change in the capacitance to an internal circuit (e.g., a touch integrated circuit (IC) or an application processor (AP)) of the electronic device.

Conventional touch panels are formed through a stack structure using an indium tin oxide (ITO) electrode. In the case of the touch panel using the ITO electrode, since light transmittance is high but resistance is large, it is difficult to implement a flexible panel.

Touch panels are also being developed in a metal mesh manner using a metal, such as copper or silver, as a material for replacing ITO. The touch panel using metal mesh has higher conductivity than a touch panel using ITO. However, since the light transmittance of the touch panel using the metal mesh is low, electrodes arranged in a lattice shape are visible to a user when the user views the touch panel from the outside.

### SUMMARY

Aspects of the present disclosure are to address at least the above-mentioned problems and/or disadvantages and to provide at least the advantages described below.

In accordance with an aspect of the present disclosure, a touch panel includes an electrode pattern including a plurality of driving electrodes and a plurality of sensing electrodes, and an insulating part formed between at least some of the plurality of driving electrodes and at least some of the plurality of sensing electrodes. The plurality of driving electrodes include a first driving electrode and a second driving electrode that are formed of a first material, a portion of the first driving electrode and a portion of the second driving electrode maintain a first distance and are disposed to be parallel with each other, the plurality of sensing electrodes include a first sensing electrode and a second sensing electrode that are formed of a second material, and a portion of the first sensing electrode and a portion of the second sensing electrode maintain a second distance different from the first distance and are disposed to be parallel with each other.

In accordance with an aspect of the present disclosure, an electronic device includes a window panel, a touch panel disposed under the window panel; and a display panel disposed under the touch panel. The touch panel includes an electrode pattern including a plurality of driving electrodes and a plurality of sensing electrodes and an insulating part formed between at least some of the plurality of driving electrodes and at least some of the plurality of sensing electrodes. The plurality of driving electrodes include a first driving electrode and a second driving electrode that are formed of a first material, and a portion of the first driving electrode and a portion of the second driving electrode maintain a first distance and are disposed to be parallel with each other. The plurality of sensing electrodes include a first sensing electrode and a second sensing electrode that are formed of a second material, and a portion of the first sensing electrode and a portion of the second sensing electrode maintain a second distance different from the first distance and are disposed to be parallel with each other.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device including a touch panel, according to an embodiment of the present disclosure;

FIG. 2 illustrates the touch panel, according to an embodiment of the present disclosure;

FIG. 3 illustrates the touch panel and a peripheral wiring part, according to an embodiment of the present disclosure;

FIG. 4 is a diagram illustrating arrangement of electrodes in an intersecting area of the touch panel, according to an embodiment of the present disclosure;

FIG. 5 is a table illustrating capacitance values of the touch panel, according to an embodiment of the present disclosure;

FIGS. 6A and 6B are exemplification diagrams illustrating insertion of a dummy pattern for improving visibility, according to an embodiment of the present disclosure;

FIGS. 7A and 7B illustrate electrode patterns of a first layer and a second layer including the dummy pattern, according to an embodiment of the present disclosure;

FIGS. 8A and 8B illustrate shapes of the dummy patterns, according to an embodiment of the present disclosure;

FIG. 9 illustrates an electronic device in a network environment, according to an embodiment of the present disclosure; and

FIG. 10 is a block diagram of the electronic device, according to an embodiment of the present disclosure.

Throughout the drawings, it should be noted that like reference numbers are used to depict the same or similar elements, features, and structures.

### DETAILED DESCRIPTION

Hereinafter, various embodiments of the present disclosure will be described with reference to the accompanying drawings. Accordingly, those of ordinary skill in the art will recognize that modifications, equivalents, and/or alternatives on the various embodiments described herein can be variously made without departing from the scope and spirit of the present disclosure. With regard to the description of drawings, similar components may be marked by similar reference numerals.

In the present disclosure, the expressions “have”, “may have”, “include” and “comprise”, or “may include” and “may comprise” used herein indicate existence of corresponding features (for example, elements such as numeric values, functions, operations, or components) but do not exclude the presence of additional features.

In the disclosure disclosed herein, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

Terms such as “first”, “second”, and the like used herein may refer to various elements of various embodiments of the present disclosure, but do not limit the elements. For example, such terms are used only to distinguish an element from another element and do not limit the order and/or priority of the elements. For example, a first user device and a second user device may represent different user devices irrespective of sequence or importance. For example, without departing the scope of the present disclosure, a first element may be referred to as a second element, and similarly, a second element may be referred to as a first element.

It will be understood that when an element (for example, a first element) is referred to as being “(operatively or communicatively) coupled with/to” or “connected to” another element (for example, a second element), it can be directly coupled with/to or connected to the other element, or an intervening element (for example, a third element) may be present. In contrast, when an element (for example, a first element) is referred to as being “directly coupled with/to” or “directly connected to” another element (for example, a second element), it should be understood that there are no intervening element (for example, a third element).

According to the situation, the expression “configured to” used herein may be used interchangeably with for example, the expressions “suitable for”, “having the capacity to”, “designed to”, “adapted to”, “made to”, or “capable of”. The term “configured to (or set to)” does not mean only “specifically designed to” in hardware. Instead, the expression “a device configured to” may mean that the device is “capable of” operating together with another device or other components. A central processing unit (CPU), for example, a “processor configured to (or set to) perform A, B, and C” may mean a dedicated processor (for example, an embedded processor) for performing a corresponding operation or a generic-purpose processor (for example, the CPU or an application processor (AP)) which may perform corresponding operations by executing one or more software programs which are stored in a memory device.

Terms used in this specification are used to describe specified embodiments of the present disclosure and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal manner unless expressly so defined herein in various embodiments of the present disclosure. In some cases, even if terms are defined in the present specification, they are not to be interpreted to exclude embodiments of the present disclosure.

An electronic device according to various embodiments of the present disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), MP3 players, mobile medical devices, cameras, and wearable devices. The wearable devices may include accessories (for example, watches, rings, bracelets, ankle bracelets, glasses, contact lenses, or head-mounted devices (HMDs)), cloth-integrated types (for example, electronic clothes), body-attached types (for example, skin pads or tattoos), or implantable types (for example, implantable circuits).

In some embodiments of the present disclosure, the electronic device may be one of home appliances. The home appliances may include, for example, at least one of a digital video disk (DVD) player, an audio, a refrigerator, an air conditioner, a cleaner, an oven, a microwave oven, a washing machine, an air cleaner, a set-top box, a home automation control panel, a security control panel, a TV box (for example, Samsung HomeSync™, Apple TV™, or Google TV™), a game console (for example, Xbox™ or PlayStation™), an electronic dictionary, an electronic key, a camcorder, or an electronic panel.

In another embodiment of the present disclosure, the electronic device may include at least one of various medical devices (for example, various portable medical measurement devices (a blood glucose meter, a heart rate measuring device, a blood pressure measuring device, and a body temperature measuring device), a magnetic resonance angiography (MRA), a magnetic resonance imaging (MRI) device, a computed tomography (CT) device, a photographing device, and an ultrasonic device), a navigation system, a global navigation satellite system (GNSS), an event data recorder (EDR), a flight data recorder (FDR), a vehicular infotainment device, electronic devices for vessels (for example, a navigation device for vessels and a gyro compass), avionics, a security device, a vehicular head unit, an industrial or home robot, an automatic teller machine (ATM) of a financial company, a point of sales (POS) terminal of a store, or an Internet of things (IoT) device (for example, a light bulb, various sensors, an electricity or gas meter, a spring cooler device, a fire alarm device, a thermostat, an electric pole, a toaster, a sporting apparatus, a hot water tank, a heater, and a boiler).

According to some embodiments of the present disclosure, the electronic device may include at least one of a furniture or a part of a building/structure, an electronic board, an electronic signature receiving device, a projector, or various measurement devices (for example, a water service, electricity, gas, or electric wave measuring device). The electronic device may be one or a combination of the aforementioned devices, and may be a flexible electronic device. Further, the electronic device according to an embodiment of the present disclosure is not limited to the aforementioned devices, but may include new electronic devices produced due to the development of technologies.

Hereinafter, electronic devices according to an embodiment of the present disclosure will be described with reference to the accompanying drawings. The term “user” used herein may refer to a person who uses an electronic device or may refer to a device (for example, an artificial intelligence electronic device) that uses an electronic device.

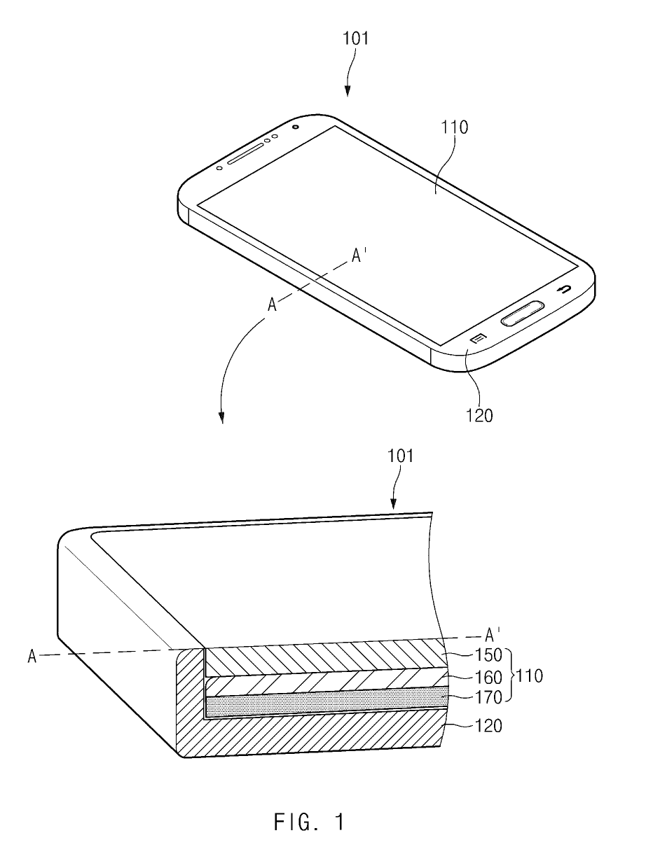

FIG. 1 illustrates an electronic device including a touch panel, according to various embodiments.

Referring to FIG. 1, an electronic device 101 may include a display module 110 and a body 120. The display module 110 may display various information (e.g., multimedia, text, images, and the like) to be provided to a user. The display module 110 may include a touch panel that senses a touch operation of a user, and the touch panel may recognize a contact touch operation or a proximity touch (e.g., hovering) operation of the user. The display module 110 may transmit a command or data input by the touch to a circuit (e.g., a touch IC, an AP, or the like) in the body 120.

The body 120 may mount and fix the display module 110. The body 120 may include various components (e.g., a touch IC, a processor, a display driver integrated circuit (DDI), a battery, and the like) for driving the display module 110. Also, the body 120 may include various components such as a communication module, a speaker module, and the like. An external appearance of the body 120 may be formed using a nonmetal material (e.g., plastic), a metal material, and the like.

Referring to a sectional view taken along lines A-A′, the display module 110 may include a window panel 150, a touch panel 160, and a display panel 170. A part such as the window panel 150 of the display module 110 may be exposed to the outside of the electronic device 101, and another part thereof may be mounted in the body 120 and may be electrically connected with an internal circuit.

The window panel 150 may be disposed at the uppermost portion of the display module 110 and may protect the touch panel 160 or the display panel 170. The window panel 150 may be formed of glass, poly carbonate (PC), poly methyl methacrylate (PMMA), polyimide (PI), and the like.

The touch panel 160 may be disposed between the window panel 150 and the display panel 170. The touch panel 160 may be formed of a light transmissive material, and an image signal displayed through the display panel 170 may pass through the touch panel 160.

According to various embodiments, the touch panel 160 may include an electrode pattern including a driving electrode and a sensing electrode and an insulation part separating the driving electrode and the sensing electrode. The driving electrode may be supplied with power from a driver module (e.g., a touch IC) in the body 120. The sensing electrode may transmit information associated with a change in capacitance by a touch operation of the user to the driver module in the body 120.

According to various embodiments, the touch panel 160 may be implemented with a structure in which a first layer, an insulating layer, and a second layer are sequentially stacked. Each of the first layer and the second layer may include an electrode pattern for recognizing a touch operation of the user. The first layer and the second layer may maintain a distance corresponding to a thickness of the insulating layer and may form a capacitor over the distance. In the case where the capacitance of the capacitor is changed by a touch operation of the user, the change may be provided to the driver module after being converted into an electrical signal.

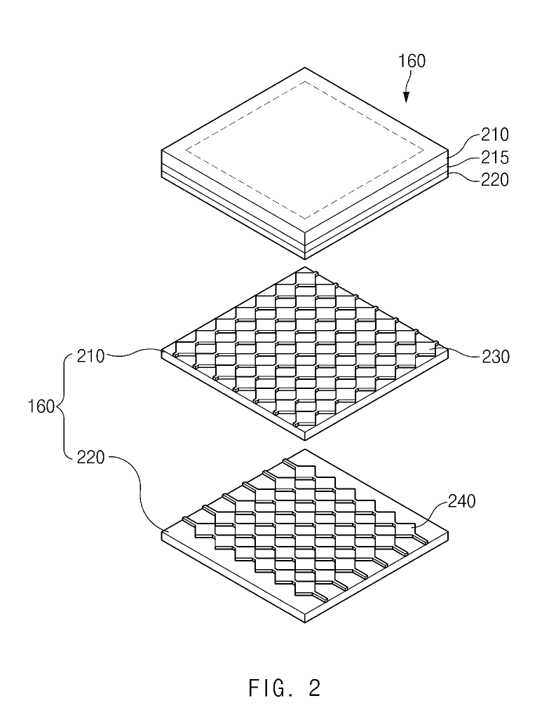

According to various embodiments, the first layer and the second layer may form electrode patterns through different materials. For example, the first layer may form an electrode pattern by using silver nano-wire, and the second layer may form an electrode pattern by using ITO. Also, arrangement shapes of the first and second layers may differ from each other based on material characteristics. Additional information about electrode patterns of the touch panel 160 will be provided with regard to FIGS. 2 to 8.

The display panel 170 may be disposed between the touch panel 160 and the body 120. The display panel 170 may display an image based on an electrical signal in the electronic device 101. The display panel 170 may be a liquid crystal display (LCD) panel, an organic light emitting diode (OLED) panel, and the like.

Adhesive layers may exist between the panels 150, 160, and 170. The adhesive layers may perform functions of adhering the corresponding panels so as not to be separated from each other and may be formed of optical clear adhesive (OCA), synthetic resins, or the like.

FIG. 2 illustrates the touch panel, according to various embodiments. The touch panel 160 is described below as including a first layer 210, an insulating layer 215, and a second layer 220. However, the present disclosure is not limited thereto. For example, the first layer 210, the insulating layer 215, and the second layer 220 may be integratedly implemented without being divided into separate layers.

Referring to FIG. 2, the touch panel 160 may sense a location, strength, and the like of a touch input of the user by using capacitance that changes with the touch input. The touch panel 160 may include the first layer 210, the insulating layer 215, and the second layer 220.

Each of the first layer 210 and the second layer 220 may include an electrode pattern for recognizing a touch operation of the user. Below, description will be given with reference to the case that the first layer 210 includes a pattern of a driving electrode (or a TX electrode) 230 and the second layer 220 includes a pattern of a sensing electrode (e.g., a RX electrode) 240. However, the present disclosure is not limited thereto. For example, the touch panel 160 may be implemented in such a way that the first layer 210 includes the sensing electrode 240 and the second layer 220 includes the driving electrode 230.

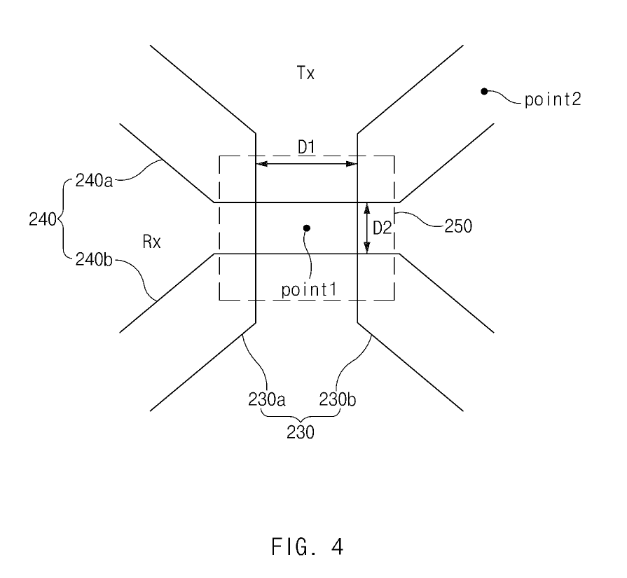

The driving electrode 230 and the sensing electrode 240 may be arranged to be intersected in a mesh shape or a matrix shape. The driving electrode 230 may be an electrical line disposed in a first direction (e.g., a vertical direction) of the touch panel 160, and the sensing electrode 240 may be an electrical line disposed in a second direction (e.g., a horizontal direction) of the touch panel 160. The driving electrode 230 and the sensing electrode 240 may be disposed to be perpendicular to each other in an overall shape and may be disposed to be parallel with each other at a partial area. For example, the driving electrode 230 and the sensing electrode 240 may be disposed to be perpendicular to each other in an area (an “intersecting area”) in which the driving electrode 230 and the sensing electrode 240 intersect and may be disposed to be parallel with each other in an area (a “connection area”) which connects intersecting areas. Additional information about shapes of the driving electrode 230 and the sensing electrode 240 will be provided with regard to FIGS. 4 to 8.

According to various embodiments, the driving electrode 230 and the sensing electrode 240 may be formed of different materials. In this case, the driving electrode 230 and the sensing electrode 240 may have different physical characteristics based on material characteristics. For example, the driving electrode 230 may be formed of silver (Ag) nano-wire, and the sensing electrode 240 may be formed using an ITO electrode. Conductivity of the driving electrode 230 using the Ag nano-wire may be higher than that of the sensing electrode 240 using ITO, and a resistance value of the driving electrode 230 using the Ag nano-wire may be smaller than that of the sensing electrode 240 using ITO. In contrast, light transmittance of the sensing electrode 240 using ITO may be larger than that of the driving electrode 230 using the Ag nano-wire, and thus, an electrode pattern may not be visible when viewed by the user from the outside.

Description will be given below with reference to the case where the first layer 210 includes the driving electrode 230 of Ag nano-wire and the second layer 220 includes the sensing electrode 240 of ITO. However, the present disclosure is not limited thereto.

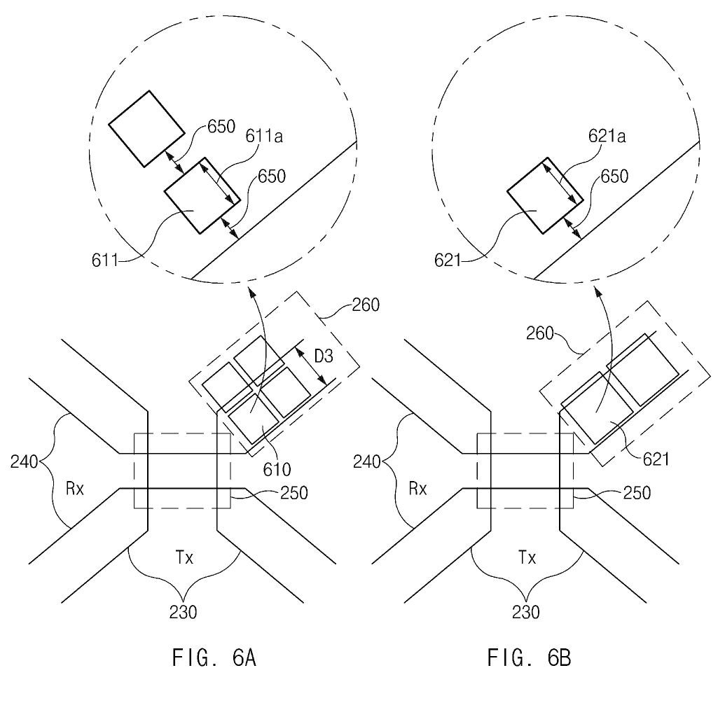

According to various embodiments, to prevent the driving electrode 230 using the Ag nano-wire from being visible from the outside, a dummy pattern may be added to the first layer 210 or the second layer 220. Additional information about the dummy pattern will be provided with regard to FIGS. 6 to 8.

According to various embodiments, in the intersecting area, in the case where the driving electrode 230 is formed of the Ag nano-wire and the sensing electrode 240 is formed of ITO, a distance between the driving electrodes 230 may be greater than a distance between the sensing electrodes 240. Since the probability that electrostatic discharge (ESD) is generated at the Ag nano-wire is higher than the probability that the ESD is generated at the ITO electrode, the probability that the ESD is generated may decrease by maintaining a distance between the driving electrodes 230 with a specified distance or more. Additional information about the arrangement of the driving electrode 230 and the sensing electrode 240 will be provided with regard to FIG. 4.

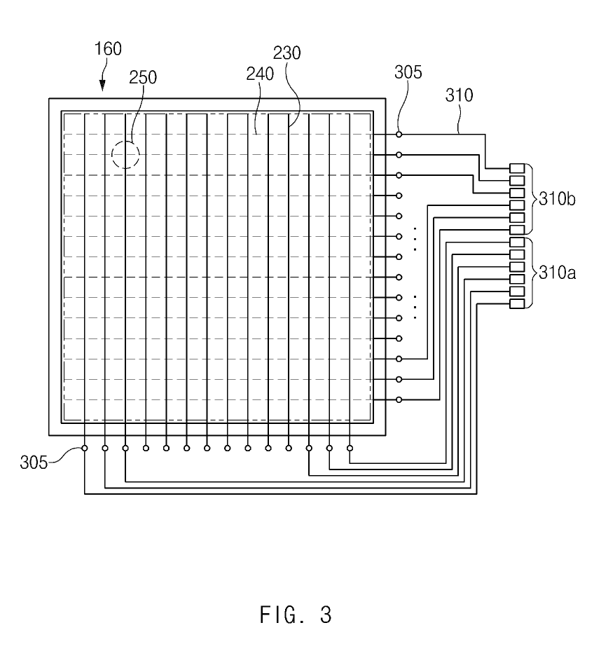

FIG. 3 illustrates the touch panel and a peripheral wiring part, according to various embodiments.

Referring to FIG. 3, the touch panel 160 may include the driving electrode 230 and the sensing electrode 240. The driving electrode 230 may be disposed in a first direction (e.g., a vertical direction) overall, and the sensing electrode 240 may be disposed in a second direction (e.g., a horizontal direction) overall. The driving electrode 230 may be disposed in the first layer, and the sensing electrode 240 may be disposed in the second layer different from the first layer.

According to various embodiments, the driving electrode 230 and the sensing electrode 240 may be disposed to intersect or to be parallel with each other at a partial area. For example, in an intersecting area 250, the driving electrode 230 and the sensing electrode 240 may be disposed to be perpendicular to each other. In contrast, in a connection area on the periphery of the intersecting area 250, the driving electrode 230 and the sensing electrode 240 may be disposed to be parallel with each other.

According to various embodiments, the driving electrode 230 or the sensing electrode 240 may be connected to a pad 305 formed at an end thereof. The pad 305 may fix each electrode and may transmit an electrical signal generated according to a touch operation to a wiring part 310. The pad 305 may be implemented with the same material as a line corresponding to the pad 305 or may be implemented with a material of which electrical conductivity is higher than that of the corresponding line.

The wiring part 310 may connect the driving electrode 230 and the sensing electrode 240 to an internal driver module (e.g., a touch IC). The wiring part 310 may include a first wiring part 310a connected to the driving electrode 230 and a second wiring part 310b connected to the sensing electrode 240. The first wiring part 310a may supply specified power provided from the driver module to the driving electrode 230. The second wiring part 310b may provide an electrical signal that has changed due to a touch operation of the user to the driver module.

In various embodiments, in the intersecting area 250, the driving electrode 230 may include a first driving electrode and a second driving electrode. The first driving electrode and the second driving electrode may maintain a first distance and may be disposed to be parallel with each other. As in the above description, in the intersecting area 250, the sensing electrode 240 may include a first sensing electrode and a second sensing electrode. The first sensing electrode and the second sensing electrode may maintain a second distance and may be disposed to be parallel with each other. For example, in the case where the driving electrode 230 is formed with the Ag nano-wire electrode, the first distance may be maintained between the Ag nano-wire electrodes. In the case where the sensing electrode 240 is formed with the ITO electrode, the second distance may be maintained between the ITO electrodes. Since the probability that the ESD is generated between the Ag nano-wire electrodes is high, to prevent an abnormal touch operation or device failure, the first distance between the Ag nano-wire electrodes may be greater than the second distance between the ITO electrodes. Additional information about the arrangement of the electrodes in the intersecting area 250 will be provided with regard to FIG. 4.

FIG. 4 is a diagram illustrating the arrangement of electrodes in the intersecting area of the touch panel, according to various embodiments.

Referring to FIG. 4, in the intersecting area 250, the driving electrode 230 and the sensing electrode 240 may be disposed to be perpendicular to each other. In contrast, in a connection area on the periphery of the intersecting area 250, the driving electrode 230 and the sensing electrode 240 may be disposed to be parallel with each other. In various embodiments, the driving electrode 230 may be disposed in the first layer, and the sensing electrode 240 may be disposed in the second layer different from the first layer.

The driving electrode 230 may include a first driving electrode 230a and a second driving electrode 230b. The first driving electrode 230a and the second driving electrode 230b may be disposed to be parallel with each other in the intersecting area 250 while maintaining a first distance D1. The ESD may be improved if the first distance D1 between the first driving electrode 230a and the second driving electrode 230b implemented with the Ag nano-wire increases. In contrast, in the case where the first distance D1 excessively increases, a capacitance (Cm) value may decrease, thereby reducing the performance of touch. The first distance D1 may be determined according to characteristics (e.g., materials of the first and second layers, ways to insulate, thicknesses, and the like) of the touch panel 160. In various embodiments, the first distance D1 may be determined to be in a range of 200 um to 500 um (e.g., 250 um).

The sensing electrode 240 may include a first sensing electrode 240a and a second sensing electrode 240b. The first sensing electrode 240a and the second sensing electrode 240b may be disposed to be parallel with each other in the intersecting area 250 while maintaining a second distance D2 different from the first distance D1. For example, the second distance D2 may be determined to be in a range of 80 um to 150 um (e.g., 100 um).

According to various embodiments, the first distance D1 may be greater than the second distance D2 and may be maintained with a specified magnification. For example, the first distance D1 may be implemented to be maintained to be 2.5 times the second distance D2.

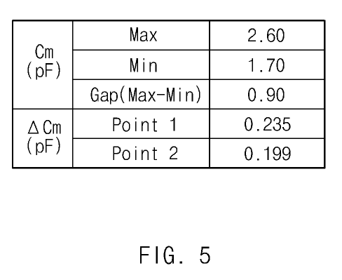

FIG. 5 is an example of a table illustrating capacitance values of the touch panel, according to various embodiments. For example, measured capacitance may change with certain characteristics (e.g., materials of the first and second layers, ways to insulate, thicknesses, and the like) of the touch panel 160, a change in a measurement frequency (e.g., 245 kHz), and the like.

Referring to FIG. 5, the touch panel 160 may sense a location, strength, and the like of a touch input of the user by using capacitance that changes with the touch input. The touch panel 160 may allow a uniform amount of current to flow to the first layer and the second layer coated with a special conducting material. If the user touches the touch panel 160, capacitance Cm between the first layer and the second layer may change, and the electronic device 101 may detect a location at which a touch of the user is made, by using the change in the capacitance Cm. For the electronic device 160 to operate normally, the capacitance Cm may be maintained within a specified specification range.

In FIG. 4, in the case where the first distance D1 is 250 um and the second distance D2 is 100 um, the capacitance Cm may be measured within a specified range (2.60 pF to 1.70 pF). A difference Gap(Max−Min) between a maximum point and a minimum point of the capacitance may be maintained at a specified value (e.g., 0.90 pF) or less such that a touch operation of the user is recognized.

Also, a capacitance variation (0.235 pF) at a first point “Point 1” being a center of the intersecting area 250 and a capacitance variation (0.199 pF) at a second point “Point 2” being an connection area on the periphery of the intersecting area 250 may have similar values, and the touch panel 160 may maintain uniform touch performance at the intersecting area 250 and a surrounding connection area.

FIGS. 6A and 6B are diagrams illustrating insertion of a dummy pattern for improving visibility, according to various embodiments.

Referring to FIGS. 6A and 6B, the touch panel 160 may include the driving electrode 230 disposed in the first layer and the sensing electrode 240 disposed in the second layer. The driving electrode 230 and the sensing electrode 240 may be disposed to be perpendicular to each other in the intersecting area 250 and may be disposed to be parallel with each other in a connection area 260.

In the case where the driving electrode 230 is implemented with the Ag nano-wire, unlike the sensing electrode 240 implemented using ITO, an issue of visibility may occur. In the case where the user views the touch panel 160 from the outside, content output through the display panel 170 may be distorted due to an opaque characteristic of the Ag nano-wire, a difference in a refractive index between electrodes, and the like.

In various embodiments, to improve the visibility of the touch panel 160, the second layer in which the sensing electrode 240 is disposed may include one or more dummy patterns 611/621. The dummy patterns 611/621 may be disposed to be adjacent to the sensing electrode 240 in the connection area 260. The dummy patterns 611/621 may be sequentially disposed in one or more columns in the connection area 260 along a direction in which an electrode is disposed. The dummy patterns 611/621 may be iteratively disposed in the same shape and at the same interval. The dummy patterns 611 and 621 may be formed of another material different from a material of the sensing electrode 240. The dummy patterns 611 and 621 may be closed electrodes of a polygon (e.g., a square).

In various embodiments, the dummy patterns 611/621 may be sequentially disposed in a direction in which the sensing electrode 240 extends. Each of the dummy patterns 611/621 may be disposed to be spaced apart from the sensing electrode 240 and a surrounding dummy pattern by a specified arrangement distance 650 (e.g., 30 um). For example, in the connection area 260, the dummy patterns 611/621 of the same shape and the same distance may be sequentially disposed in a direction parallel with the sensing electrode 240.

In various embodiments, the dummy patterns 611/621 may be disposed in a plurality of columns on the periphery of the sensing electrode 240. For example, dummy patterns of a first column may be disposed along a first line that is adjacent to or parallel with the sensing electrode 240. Dummy patterns of a second column may be disposed along a second line that is adjacent to and parallel with the first column of dummy patterns. Dummy patterns of a third column may be disposed along a third line that is adjacent to and parallel with the second column of dummy patterns. Below, the case where the dummy patterns 611/621 are disposed in the first column or the second column is described. However, the present disclosure is not limited thereto. For example, the dummy patterns 611/621 may be disposed in three or more columns.

Referring to FIG. 6A, a width (or a length of one side) 611a of the dummy pattern 611 may be formed to be the same as or smaller than an arrangement distance D3 between the driving electrode 230 and the sensing electrode 240. For example, in the case where the arrangement distance D3 is 200 um, the width 611a of the dummy pattern 611 may be determined to be between 100 um to 200 um.

Referring to FIG. 6B, a width (or a length of one side) 621a of the dummy pattern 621 may be formed to be larger than the arrangement distance D3 between the driving electrode 230 and the sensing electrode 240. For example, in the case where the arrangement distance D3 is 200 um, the width 621a of the dummy pattern 621 may be determined to be 300 um. In this case, the dummy pattern 621 may be disposed to overlap the driving electrode 230 disposed in the first layer. In the case where the dummy pattern 621 becomes excessively large, a parasitic capacitor may be formed between the dummy pattern 621 and a surrounding electrode, and the performance of touch may decrease due to the parasitic capacitor. The size of the dummy pattern 621 may be determined to be less than or equal to a specified size or may be determined such that a value of a parasitic capacitor is less than or equal to a specified value.

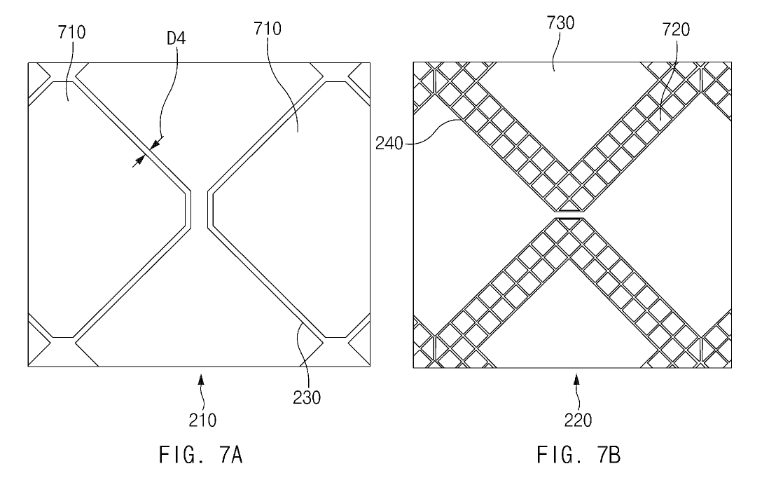

FIGS. 7A and 7B illustrate examples of electrode patterns of the first layer and the second layer including the dummy pattern, according to various embodiments.

Referring to FIG. 7A, the first layer 210 may include the driving electrode 230 and a first dummy pattern 710. The driving electrode 230 and the first dummy pattern 710 may be implemented with the Ag nano-wire.

The first dummy pattern 710 may be disposed to cover the remaining area of an area in which the driving electrode 230 is disposed. The first dummy pattern 710 may be formed to be surrounded by the driving electrode 230. The first dummy pattern 710 may prevent a pattern of the first layer 210 from being visible from the outside when a display panel under the touch panel 160 is turned on/off.

According to various embodiments, a distance D4 between at least one side of the first dummy pattern 710 and the driving electrode 230 may have a range of 0 to 30 um.

Referring to FIG. 7B, the second layer 220 may include the sensing electrode 240, a second dummy pattern 720, and a third dummy pattern 730. In various embodiments, the sensing electrode 240, the second dummy pattern 720, and the third dummy pattern 730 may be implemented using ITO.

The second dummy patterns 720 may be sequentially disposed in one or more columns along the sensing electrode 240 in a connection area. The second dummy pattern 720 may be formed such that a pattern of the same shape (e.g., a square) is iteratively disposed at specified intervals. The case in which the second dummy patterns 720 are disposed in two columns is illustrated in FIG. 7B. However, the present disclosure is not limited thereto. The second dummy patterns 720 may be disposed in three or more columns.

In various embodiments, a width of the second dummy pattern 720 may be larger than a distance between the driving electrode 230 and the sensing electrode 240. The dummy pattern 720 may be disposed to overlap the driving electrode 230 disposed in the first layer 210.

The third dummy pattern 730 may be disposed to cover the remaining area other than an area in which the sensing electrode 240 and the second dummy pattern 720 are disposed. The third dummy pattern 730 may be formed to be surrounded by the second dummy pattern 720. The third dummy pattern 730 may improve pattern visibility of the first layer 210 implemented with the Ag nano-wire when a display panel under the touch panel 160 is turned on/off.

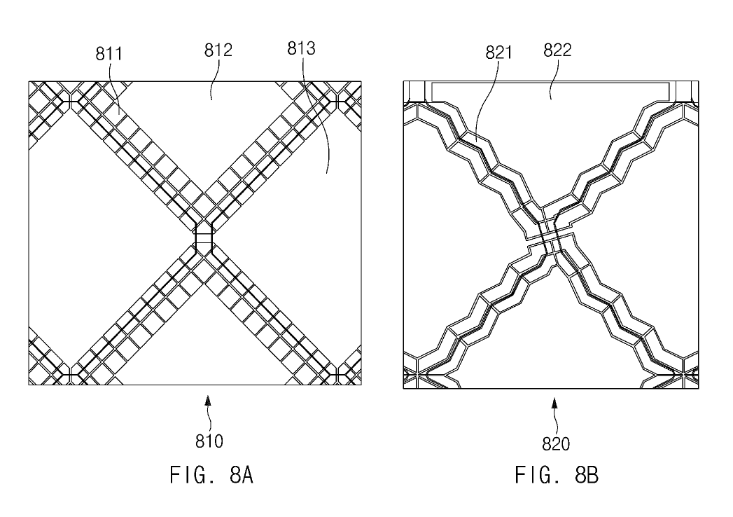

FIGS. 8A and 8B illustrate examples of shapes of dummy patterns, according to various embodiments.

Referring to FIG. 8A, a touch panel 810 may be formed in such a way that the first layer 210 and the second layer 220 of FIGS. 7A and 7B are stacked. The driving electrode 230 of the first layer 210 and the sensing electrode 240 of the second layer 220 may be perpendicular to each other in an intersecting area and may be parallel with each other in a connection area.

A dummy pattern 811 may be disposed between the driving electrode 230 and the sensing electrode 240 in a connection area of the second layer 220. The dummy pattern 811 may fill a space between the driving electrode 230 and the sensing electrode 240 to prevent an electrode pattern from being visible from the outside due to a difference in a refractive index.

The dummy pattern 812 may be disposed to cover the remaining area other than an area in which the sensing electrode 240 and the dummy pattern 811 are disposed, in the second layer 220. The dummy pattern 812 may be formed to be surrounded by the dummy pattern 811.

The dummy pattern 813 may be disposed to cover the remaining area other than an area in which the driving electrode 230 is disposed, in the first layer 210. The dummy pattern 813 may prevent a pattern of the first layer 210 from being visible from the outside when a display panel under the touch panel 810 is turned on/off.

Referring to FIG. 8B, in a touch panel 820, a direction of an electrode pattern may be changed according to each interval in a connection area that connects intersecting areas. In this case, the driving electrode 230 and the sensing electrode 240 may maintain a parallel shape in each interval.

A dummy pattern 821 may have various shapes to correspond to shapes of the driving electrode 230 and the sensing electrode 240. The dummy pattern 821 may fill a space between the driving electrode 230 and the sensing electrode 240 to prevent an electrode pattern from being visible from the outside due to a difference in a refractive index. A dummy pattern 822 may have various shapes to correspond to a side surface adjacent to the dummy pattern 821.

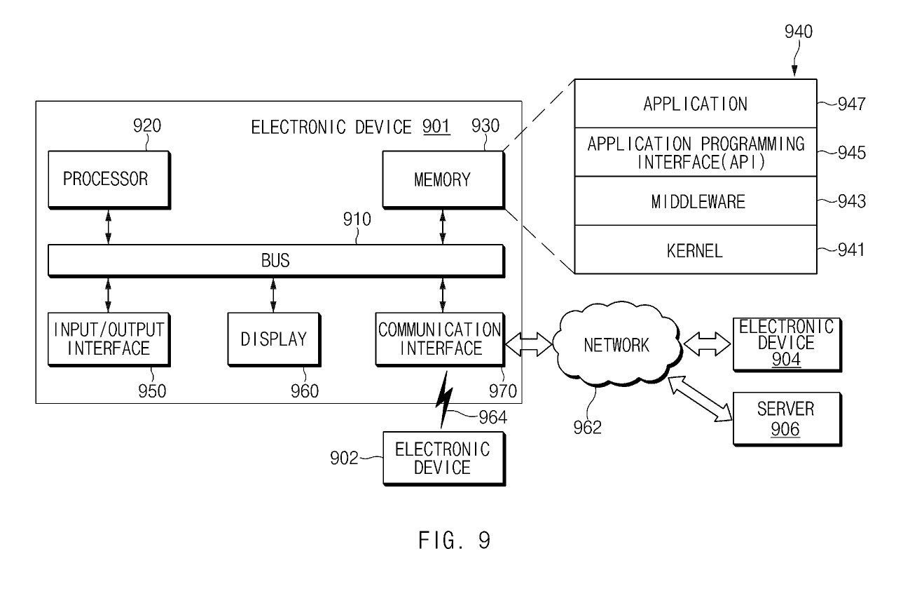

FIG. 9 is a diagram illustrating an electronic device in a network environment, according to various embodiments of the present disclosure.

Referring to FIG. 9, there is illustrated an electronic device 901 in a network environment. The electronic device 901 may include a bus 910, a processor 920, a memory 930, an input/output (I/O) interface 950, a display 960, and a communication interface 970. According to an embodiment, the electronic device 901 may not include at least one of the above-described elements or may include other element(s).

For example, the bus 910 may interconnect the above-described elements 920 to 970 and may include a circuit for conveying communications (e.g., a control message and/or data) among the above-described elements.

The processor 920 may include one or more of a central processing unit (CPU), an application processor (AP), or a communication processor (CP). The processor 920 may perform, for example, data processing or an operation associated with control and/or communication of at least one other element(s) of the electronic device 901.

The memory 930 may include a volatile and/or nonvolatile memory. For example, the memory 930 may store instructions or data associated with at least one other element(s) of the electronic device 901. According to an embodiment, the memory 930 may store software and/or a program 940. The program 940 may include, for example, a kernel 941, a middleware 943, an application programming interface (API) 945, and/or an application program(s) (or “applications”) 947. At least a part of the kernel 941, the middleware 943, or the API 945 may be called an “operating system (OS)”.

The kernel 941 may control or manage system resources (e.g., the bus 910, the processor 920, the memory 930, and the like) that are used to execute operations or functions of other programs (e.g., the middleware 943, the API 945, and the applications 947). Furthermore, the kernel 941 may provide an interface that allows the middleware 943, the API 945, or the applications 947 to access discrete elements of the electronic device 901 so as to control or manage system resources.

The middleware 943 may perform a mediation role such that the API 945 or the applications 947 communicate with the kernel 941 to exchange data.

Furthermore, the middleware 943 may process one or more task requests received from the applications 947 according to a priority. For example, the middleware 943 may assign the priority, which makes it possible to use a system resource (e.g., the bus 910, the processor 920, the memory 930, or the like) of the electronic device 901, to at least one of the applications 947. For example, the middleware 943 may process the one or more task requests according to the priority assigned to the at least one application 947, which makes it possible to perform scheduling or load balancing on the one or more task requests.

The API 945 may be an interface through which the applications 947 control a function provided by the kernel 941 or the middleware 943, and may include, for example, at least one interface or function (e.g., an instruction) for a file control, a window control, image processing, a character control, or the like.

The I/O interface 950 may transmit an instruction or data, input from a user or another external device, to other element(s) of the electronic device 901. Furthermore, the I/O interface 950 may output an instruction or data, received from other element(s) of the electronic device 901, to a user or another external device.

The display 960 may include, for example, a liquid crystal display (LCD), a light-emitting diode (LED) display, an organic LED (OLED) display, a microelectromechanical systems (MEMS) display, or an electronic paper display. The display 960 may display, for example, various kinds of content (e.g., a text, an image, a video, an icon, a symbol, and the like) to a user. The display 960 may include a touch screen and may receive, for example, a touch, gesture, proximity, or hovering input using an electronic pen or a portion of a user's body.

The communication interface 970 may establish communication between the electronic device 901 and an external device (e.g., a first external electronic device 902, a second external electronic device 904, or a server 906). For example, the communication interface 970 may be connected to a network 962 through wireless communication or wired communication to communicate with an external device 904 or the server 906).

The wireless communication may include at least one of, for example, LTE (long-term evolution), LTE-A (LTE advance), CDMA (code division multiple access), WCDMA (wideband CDMA), UMTS (universal mobile telecommunications system), WiBro (wireless broadband), or GSM (global system for mobile communications), and the like, as cellular communication protocol. Furthermore, the wireless communication may include, for example, a local area network 964. The local area network 964 may include at least one of a wireless fidelity (Wi-Fi), a near field communication (NFC), magnetic stripe transmission (MST), a global navigation satellite system (GNSS), or the like.

The MST may generate a pulse in response to transmission data using an electromagnetic signal, and the pulse may generate a magnetic field signal. The electronic device 901 may transfer the magnetic field signal to a POS terminal, and the POS terminal may detect the magnetic field signal using an MST reader. The POS terminal may recover the data by converting the detected magnetic field signal to an electrical signal.

The GNSS may include at least one of a global positioning system (GPS), a global navigation satellite system (Glonass), a Beidou Navigation Satellite System (Beidou), the European global satellite-based navigation system (Galileo), or the like. In this specification, “GPS” and “GNSS” may be used interchangeably.

The wired communication may include at least one of, for example, a universal serial bus (USB), a high definition multimedia interface (HDMI), a recommended standard-232 (RS-232), a plain old telephone service (POTS), or the like. The network 962 may include at least one of telecommunications networks, for example, a computer network (e.g., LAN or WAN), an Internet, or a telephone network.

Each of the first and second external electronic devices 902 and 904 may be a device of which the type is different from or the same as that of the electronic device 901. The server 906 may include a group of one or more servers. All or a portion of operations that the electronic device 901 will perform may be executed by another or a plurality of electronic devices 902 and 904, or the server 906. When the electronic device 901 executes any function or service automatically or in response to a request, the electronic device 901 may not perform the function or the service internally, but alternatively or additionally, it may request at least a part of a function associated with the electronic device 901 to be performed at the other electronic device 902 or 904, or the server 906. The other electronic device may execute the requested function or additional function and may transmit the execution result to the electronic device 901. The electronic device 901 may provide the requested function or service using the received result or may additionally process the received result to provide the requested function or service. To this end, for example, cloud computing, distributed computing, or client-server computing may be used.

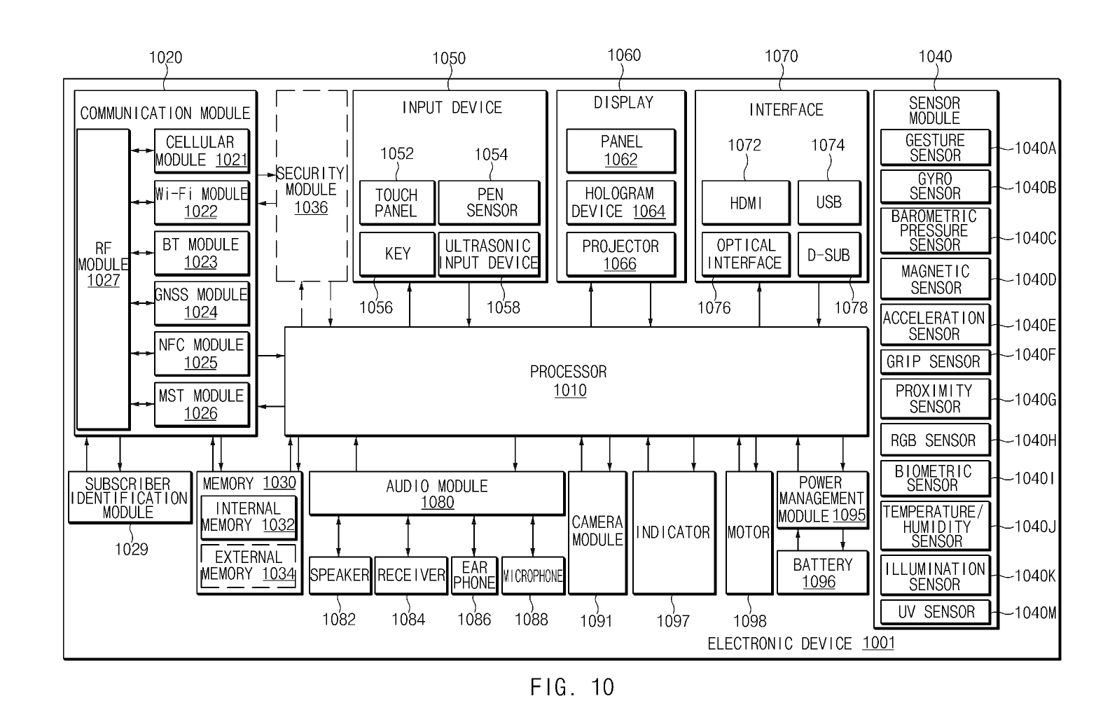

FIG. 10 is a block diagram illustrating a configuration of an electronic device according to an embodiment of the present disclosure.

Referring to FIG. 10, the electronic device 1001 may include, for example, all or part of an electronic device 901 shown in FIG. 9. The electronic device 1001 may include one or more processors 1010 (e.g., application processors (APs)), a communication module 1020, a subscriber identification module (SIM) 1029, a memory 1030, a security module 1036, a sensor module 1040, an input device 1050, a display 1060, an interface 1070, an audio module 1080, a camera module 1091, a power management module 1095, a battery 1096, an indicator 1097, and a motor 1098.

The processor 1010 may drive, for example, an operating system (OS) or an application program to control a plurality of hardware or software components connected thereto and may process and compute a variety of data. The processor 1010 may be implemented with, for example, a system on chip (SoC). The processor 1010 may include a graphic processing unit (GPU) (not shown) and/or an image signal processor. The processor 1010 may include at least some (e.g., a cellular module 1021) of the components shown in FIG. 10. The processor 1010 may load a command or data received from at least one of the other components (e.g., a non-volatile memory) into a volatile memory to process the data and may store various data in a non-volatile memory.

The communication module 1020 may have the same or similar configuration to the communication interface 970 of FIG. 9. The communication module 1020 may include, for example, the cellular module 1021, a wireless-fidelity (Wi-Fi) module 1022, a Bluetooth (BT) module 1023, a global navigation satellite system (GNSS) module 1024 (e.g., a GPS module, a Glonass module, a Beidou module, or a Galileo module), a near field communication (NFC) module 1025, and an MST module 1026.

The cellular module 1021 may provide, for example, a voice call service, a video call service, a text message service an Internet service, and the like through a communication network. The cellular module 1021 may identify and authenticate the electronic device 1001 in a communication network using the SIM 1029 (e.g., a SIM card). The cellular module 1021 may perform at least part of functions which may be provided by the processor 1010. The cellular module 1021 may include a communication processor (CP).

The Wi-Fi module 1022, the BT module 1023, the GNSS module 1024, the NFC module 1025, or the MST module 1026 may include, for example, a processor for processing data transmitted and received through the corresponding module. At least some (e.g., two or more) of the cellular module 1021, the Wi-Fi module 1022, the BT module 1023, the GNSS module 1024, the NFC module 1025, or the MST module 1026 may be included in one integrated chip (IC) or one IC package.

The SIM 1029 may include, for example, a card which includes a SIM and/or an embedded SIM. The SIM 1029 may include unique identification information (e.g., an integrated circuit card identifier (ICCID)) or subscriber information (e.g., an international mobile subscriber identity (IMSI)).

The memory 1030 (e.g., a memory 930 of FIG. 9) may include, for example, an embedded (internal) memory 1032 or an external memory 1034. The internal memory 1032 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1034 may include a flash drive, for example, a compact flash (CF), a secure digital (SD), a micro-SD, a mini-SD, an extreme digital (xD), a multimedia car (MMC), or a memory stick, and the like. The external memory 1034 may operatively and/or physically connect with the electronic device 1001 through various interfaces.

The security module 1036 may be a module which has a relatively higher secure level than the memory 1030 and may be a circuit which stores secure data and guarantees a protected execution environment. The security module 1036 may be implemented with a separate circuit and may include a separate processor. The security module 1036 may include, for example, an embedded secure element (eSE) which is present in a removable smart chip or a removable SD card or is embedded in a fixed chip of the electronic device 1001. Also, the security module 1036 may be driven by an OS different from the OS of the electronic device 1001. For example, the security module 1036 may operate based on a java card open platform (JCOP) OS.

The sensor module 1040 may measure, for example, a physical quantity or may detect an operation state of the electronic device 1001, and may convert the measured or detected information to an electric signal. The sensor module 1040 may include at least one of, for example, a gesture sensor 1040A, a gyro sensor 1040B, a barometric pressure sensor 1040C, a magnetic sensor 1040D, an acceleration sensor 1040E, a grip sensor 1040F, a proximity sensor 1040G, a color sensor 1040H (e.g., red, green, blue (RGB) sensor), a biometric sensor 1040I, a temperature/humidity sensor 1040J, an illumination sensor 1040K, or an ultraviolet (UV) sensor 1040M. Additionally or alternatively, the sensor module 1040 may further include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor, and the like. The sensor module 1040 may further include a control circuit for controlling at least one or more sensors included therein. The electronic device 1001 may further include a processor configured to control the sensor module 1040, as part of the processor 1010 or to be independent of the processor 1010. While the processor 1010 is in a sleep state, the electronic device 1001 may control the sensor module 1040.

The input device 1050 may include, for example, a touch panel 1052, a (digital) pen sensor 1054, a key 1056, or an ultrasonic input device 1058. The touch panel 1052 may use at least one of, for example, a capacitive type, a resistive type, an infrared type, or an ultrasonic type. Also, the touch panel 1052 may include a control circuit. The touch panel 1052 may further include a tactile layer and may provide a tactile reaction to a user.

The (digital) pen sensor 1054 may be, for example, part of the touch panel 1052 or may include a separate sheet for recognition. The key 1056 may include, for example, a physical button, an optical key, or a keypad. The ultrasonic input device 1058 may allow the electronic device 1001 to detect a sound wave using a microphone 1088 and to verify data through an input tool generating an ultrasonic signal.

The display 1060 may include a panel 1062, a hologram device 1064, or a projector 1066. The panel 1062 may include the same or similar configuration to the display 960. The panel 1062 may be implemented to be, for example, flexible, transparent, or wearable. The panel 1062 and the touch panel 1052 may be integrated into one module. The hologram device 1064 may show a stereoscopic image in a space using interference of light. The projector 1066 may project light onto a screen to display an image. The screen may be positioned, for example, inside or outside the electronic device 1001. The display 1060 may further include a control circuit for controlling the panel 1062, the hologram device 1064, or the projector 1066.

The interface 1070 may include, for example, a high-definition multimedia interface (HDMI) 1072, a universal serial bus (USB) 1074, an optical interface 1076, or a D-subminiature 1078. The interface 1070 may be included in, for example, the communication interface 970 shown in FIG. 9. Additionally or alternatively, the interface 1070 may include, for example, a mobile high definition link (MHL) interface, an SD card/multimedia card (MMC) interface, or an infrared data association (IrDA) standard interface.

The audio module 1080 may convert a sound and an electric signal in dual directions. At least part of components of the audio module 1080 may be included in, for example, an input and output interface 950 (or a user interface) shown in FIG. 9. The audio module 1080 may process sound information input or output through, for example, a speaker 1082, a receiver 1084, an earphone 1086, the microphone 1088, and the like.

The camera module 1091 may be a device which captures a still image and a moving image. The camera module 1091 may include one or more image sensors (e.g., a front sensor or a rear sensor), a lens, an image signal processor (ISP), or a flash (e.g., an LED or a xenon lamp).

The power management module 1095 may manage, for example, power of the electronic device 1001. The power management module 1095 may include a power management integrated circuit (PMIC), a charger IC, or a battery gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1096 and voltage, current, or temperature thereof while the battery 1096 is charging. The battery 1096 may include, for example, a rechargeable battery or a solar battery.

The indicator 1097 may display a specific state of the electronic device 1001 or part (e.g., the processor 1010) thereof, for example, a booting state, a message state, or a charging state, and the like. The motor 1098 may convert an electric signal into mechanical vibration and may generate vibration or a haptic effect, and the like. The electronic device 1001 may include a processing unit (e.g., a GPU) for supporting a mobile TV. The processing unit for supporting the mobile TV may process media data according to certain standards, including for example, a digital multimedia broadcasting (DMB) standard, a digital video broadcasting (DVB) standard, or a MediaFLO™ standard, and the like.

Each of the above-mentioned elements of the electronic device according to various embodiments of the present disclosure may be configured with one or more components, and names of the corresponding elements may be changed according to the type of the electronic device. The electronic device may include at least one of the above-mentioned elements, some elements may be omitted from the electronic device, or other additional elements may be further included in the electronic device. Also, some of the elements of the electronic device may be combined with each other to form one entity, thereby making it possible to perform the functions of the corresponding elements in the same manner as before the combination.

According to various embodiments, a touch panel includes an electrode pattern including a plurality of driving electrodes and a plurality of sensing electrodes and an insulating part formed between at least some of the plurality of driving electrodes and at least some of the plurality of sensing electrodes, wherein the plurality of driving electrodes include a first driving electrode and a second driving electrode that are formed of a first material, wherein a portion of the first driving electrode and a portion of the second driving electrode maintain a first distance and are disposed to be parallel with each other, wherein the plurality of sensing electrodes include a first sensing electrode and a second sensing electrode that are formed of a second material, and wherein a portion of the first sensing electrode and a portion of the second sensing electrode maintain a second distance different from the first distance and are disposed to be parallel with each other.

At least a portion of the first material includes silver (Ag) nano-wire.

At least a portion of the second material includes indium tin oxide (ITO).

The first distance is within a range of 200 um to 500 um.

The second distance is within a range of 80 um to 150 um.

The first distance is larger than the second distance and forms a specified magnification with the second distance.

According to various embodiments, the electrode pattern further includes a dummy pattern disposed to be adjacent to at least some of the plurality of driving electrodes or at least some of the plurality of sensing electrodes. The dummy pattern includes a closed electrode of a polygon disposed to be parallel with the at least some of the plurality of sensing electrodes. The dummy pattern is formed such that a distance between at least one side of the polygon and the at least some of the plurality of sensing electrodes adjacent satisfies a range of 30 um or less, in a parallel interval. The dummy pattern includes a plurality of patterns disposed to be parallel with the at least some of the plurality of sensing electrodes. The dummy pattern is formed of another material different from a corresponding electrode among the at least some of the plurality of driving electrodes and the at least some of the plurality of sensing electrodes. The dummy pattern includes a closed electrode of a polygon disposed to be parallel with the at least some of the plurality of sensing electrodes. The dummy pattern is formed such that a distance between at least one side of the polygon and the at least some of the plurality of driving electrodes adjacent satisfies a range of 30 um or less, in a parallel interval.

The plurality of driving electrodes are formed in a first layer, wherein the plurality of sensing electrodes are formed in a second layer different from the first layer, and wherein the insulating part includes an insulating layer disposed between the first layer and the second layer. The portion of the first driving electrode is disposed to be perpendicular to the portion of the first sensing electrode and the portion of the second sensing electrode in space, and wherein another portion of the first driving electrode is disposed to be parallel with another portion of the first sensing electrode and another portion of the second sensing electrode in space.

According to various embodiments, an electronic device includes a window panel, a touch panel disposed under the window panel and a display panel disposed under the touch panel, wherein the touch panel includes an electrode pattern including a plurality of driving electrodes and a plurality of sensing electrodes and an insulating part formed between at least some of the plurality of driving electrodes and at least some of the plurality of sensing electrodes, wherein the plurality of driving electrodes include a first driving electrode and a second driving electrode that are formed of a first material, and a portion of the first driving electrode and a portion of the second driving electrode maintain a first distance and are disposed to be parallel with each other, and wherein the plurality of sensing electrodes include a first sensing electrode and a second sensing electrode that are formed of a second material, and a portion of the first sensing electrode and a portion of the second sensing electrode maintain a second distance different from the first distance and are disposed to be parallel with each other.

At least a portion of the first material includes Ag nano-wire, and wherein at least a portion of the second material includes ITO.

The first distance is larger than the second distance and forms a specified magnification with the second distance.

The electrode pattern includes a dummy pattern disposed to be adjacent to the at least some of the plurality of driving electrodes and the at least some of the plurality of sensing electrodes.

The plurality of driving electrodes are formed in a first layer, wherein the plurality of sensing electrodes are formed in a second layer different from the first layer, and wherein the insulating part includes an insulating layer disposed between the first layer and the second layer. The portion of the first driving electrode is disposed to be perpendicular to the portion of the first sensing electrode and the portion of the second sensing electrode in space, and wherein another portion of the first driving electrode is disposed to be parallel with another portion of the first sensing electrode and another portion of the second sensing electrode in space.

A touch panel and an electronic device using the same may improve the performance of touch and may reduce electrostatic discharge (ESD), by forming a touch panel by using electrodes of two or more different materials and disposing electrodes based on characteristics of the respective materials.

The touch panel and the electronic device using the same may improve visibility of a panel of a metal mesh manner based on the Ag nano-wire by using dummy patterns of various shapes.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A touch panel comprising:
an electrode pattern including a plurality of driving electrodes and a plurality of sensing electrodes; and
an insulating part formed between at least some of the plurality of driving electrodes and at least some of the plurality of sensing electrodes,
wherein the plurality of driving electrodes include a first driving electrode and a second driving electrode that are formed of a first material,
wherein a portion of the first driving electrode and a portion of the second driving electrode maintain a first distance and are disposed to be parallel with each other,
wherein the plurality of sensing electrodes include a first sensing electrode and a second sensing electrode that are formed of a second material, and
wherein a portion of the first sensing electrode and a portion of the second sensing electrode maintain a second distance different from the first distance and are disposed to be parallel with each other.

2. The touch panel of claim 1, wherein the first material includes silver (Ag) nano-wire.

3. The touch panel of claim 1, wherein the second material includes indium tin oxide (ITO).

4. The touch panel of claim 1, wherein the first distance is within a range of 200 um to 500 um.

5. The touch panel of claim 1, wherein the second distance is within a range of 80 um to 150 um.

6. The touch panel of claim 1, wherein the first distance is larger than the second distance and forms a specified magnification with the second distance.

7. The touch panel of claim 1, wherein the electrode pattern further includes a dummy pattern disposed to be adjacent to at least some of the plurality of driving electrodes or at least some of the plurality of sensing electrodes.

8. The touch panel of claim 7, wherein the dummy pattern includes a closed electrode in a polygon shape disposed to be parallel with the at least some of the plurality of sensing electrodes.

9. The touch panel of claim 8, wherein the dummy pattern is formed such that a distance between at least one side of the polygon and the at least some of the plurality of sensing electrodes adjacent is within a range of 30 um or less, in a parallel interval.

10. The touch panel of claim 8, wherein the dummy pattern includes a plurality of patterns disposed to be parallel with the at least some of the plurality of sensing electrodes.

11. The touch panel of claim 7, wherein the dummy pattern is formed of another material different from a corresponding electrode among the at least some of the plurality of driving electrodes and the at least some of the plurality of sensing electrodes.

12. The touch panel of claim 7, wherein the dummy pattern includes a closed electrode of a polygon disposed to be parallel with the at least some of the plurality of sensing electrodes.

13. The touch panel of claim 1, wherein the plurality of driving electrodes are formed in a first layer,
wherein the plurality of sensing electrodes are formed in a second layer different from the first layer, and
wherein the insulating part includes an insulating layer disposed between the first layer and the second layer.

14. The touch panel of claim 13, wherein the portion of the first driving electrode is disposed to be perpendicular to the portion of the first sensing electrode and the portion of the second sensing electrode in space, and
wherein another portion of the first driving electrode is disposed to be parallel with another portion of the first sensing electrode and another portion of the second sensing electrode in space.

15. An electronic device comprising:
a window panel;
a touch panel disposed under the window panel; and
a display panel disposed under the touch panel,
wherein the touch panel includes an electrode pattern including a plurality of driving electrodes and a plurality of sensing electrodes and an insulating part formed between at least some of the plurality of driving electrodes and at least some of the plurality of sensing electrodes,
wherein the plurality of driving electrodes include a first driving electrode and a second driving electrode that are formed of a first material, and a portion of the first driving electrode and a portion of the second driving electrode maintain a first distance and are disposed to be parallel with each other, and
wherein the plurality of sensing electrodes include a first sensing electrode and a second sensing electrode that are formed of a second material, and a portion of the first sensing electrode and a portion of the second sensing electrode maintain a second distance different from the first distance and are disposed to be parallel with each other.

16. The electronic device of claim 15, wherein the first material includes Ag nano-wire, and
wherein the second material includes ITO.

17. The electronic device of claim 15, wherein the first distance is larger than the second distance and forms a specified magnification with the second distance.

18. The electronic device of claim 15, wherein the electrode pattern includes a dummy pattern disposed to be adjacent to the at least some of the plurality of driving electrodes and the at least some of the plurality of sensing electrodes.

19. The electronic device of claim 15, wherein the plurality of driving electrodes are formed in a first layer,
wherein the plurality of sensing electrodes are formed in a second layer different from the first layer, and
wherein the insulating part includes an insulating layer disposed between the first layer and the second layer.

20. The electronic device of claim 19, wherein the portion of the first driving electrode is disposed to be perpendicular to the portion of the first sensing electrode and the portion of the second sensing electrode in space, and
wherein another portion of the first driving electrode is disposed to be parallel with another portion of the first sensing electrode and another portion of the second sensing electrode in space.
